(19) United States
(12) Patent Application Publication
(10) Pub. No.: US 2019/0035555 A1
(43) Pub. Date: Jan. 31, 2019

(54) Increased Operational Temperature of BOPP Based Capacitors by Fluorination of Film

(71) Applicant: KEMET Electronics Corporation, Simpsonville, SC (US)

(72) Inventor: Marco Michelazzi, Sasso Marconi (IT)

(73) Assignee: KEMET Electronics Corporation

(21) Appl. No.: 16/044,687

(22) Filed: Jul. 25, 2018

Related U.S. Application Data
(60) Provisional application No. 62/537,671, filed on Jul. 27, 2017.

(51) Int. Cl. H01G 4/18; C08J 5/18; C08F 110/06; C08L 23/12

(52) U.S. Cl. CPC H01G 4/18; C08J 5/18; C08F 110/06; C08L 2203/16; B29K 2223/10; C08J 2323/12; C08L 23/12

(57) ABSTRACT

An improved film capacitor which is suitable for use at higher operating temperatures is described. The capacitor has a first fluorinated biaxially oriented polypropylene film and a conductive coating on at least one side of the first fluorinated biaxially oriented polypropylene film.

### CROSS-REFERENCE TO RELATED APPLICATIONS

The present invention claims priority to pending U.S. Provisional Patent Application No. 62/537,671 filed Jul. 27, 2017 which is incorporated herein by reference.

### FIELD OF THE INVENTION

The present invention is related to a film capacitor comprising a conductor, preferably a metal, on a biaxially oriented polypropylene film (BOPP) wherein the BOPP is a fluorinated biaxially oriented polypropylene film (FBOPP).

### BACKGROUND

Film capacitors have been widely used throughout the electronics industry. A film capacitor comprises a polymer film, which functions as a dielectric, with a metal coated on at least one side of the film. The film is then typically layered such that the conductive coatings of adjacent layers are separated by a single layer of film as known in the art.

There has been a long standing, and increasing demand, for capacitors with higher capacitance suitable for use in higher temperature environments. Film capacitors are suitable for higher capacitance, however, the film is susceptible to damage at high temperatures, especially, if polypropylene is utilized as the dielectric film.

BOPP is the material of choice for film capacitors, particularly, in automotive applications, due to its low dissipation factor, high dielectric strength and high self-healing ability. The use of BOPP as the dielectric in a film capacitor has been limited by the low operational temperature. Typically employed high temperature materials are generally electrically inferior to BOPP due to inferior dielectric characteristics and the lack of availability in the correct thickness. Provided herein is a method for modifying BOPP film that can increase its operational temperature. The process is suitable for use with films of desired thickness thereby circumventing the difficulties related to biaxial stretching of high temperature materials.

Polypropylene based dielectric films have therefore never been considered suitable for use in high temperature applications. The present invention provides a fluorinated biaxially stretched polypropylene film suitable for use in higher temperature applications.

### SUMMARY OF THE INVENTION

The present invention relates to a film capacitor suitable for use in higher temperature applications.

More specifically, the present invention is related to a film capacitor comprising a conductive, preferably metal, coating on at least one side of a fluorinated biaxially oriented polypropylene (FBOPP) film.

Even more specifically, the present invention is related to a film capacitor comprising a layered structure wherein at least one layer of the layered structure comprises a fluorinated biaxially oriented polypropylene film comprising a conductive, preferably metal, coating on at least one side of the fluorinated biaxially stretched polypropylene film.

Yet another embodiment is provided in a film capacitor comprising a first fluorinated biaxially oriented polypropylene film and a conductive coating on at least one side of the first fluorinated biaxially oriented polypropylene film.

Yet another embodiment is provided in a process for forming a film capacitor comprising:
fluorinating a biaxial oriented polypropylene film to obtain a first fluorinated biaxial oriented polypropylene film;
forming a conductive coating on the first fluorinated biaxial oriented polypropylene film to form a first layer; and
forming a layered structure comprising the first layer and a second layer.

### BRIEF DESCRIPTION OF DRAWINGS

FIG. 1 illustrates an embodiment of the invention.

FIG. 2 illustrates an embodiment of the invention.

FIG. 3 is a DSC scan.

FIGS. 4 and 5 are graphical representation of the shrinkage as a function of temperature.

### DESCRIPTION

The present invention is related to improved film capacitors and more specifically to improved film capacitors based on biaxially oriented polypropylene film (BOPP) as the dielectric wherein the BOPP is fluorinated BOPP (FBOPP).

The invention will be described with reference to the figures which form an integral, non-limiting component of the disclosure. Throughout the various figures similar elements will be number accordingly.

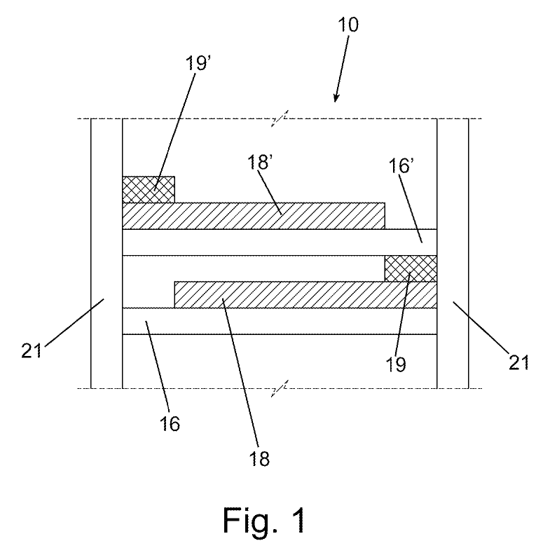

An embodiment of the invention will be described with reference to FIG. 1 wherein a working element is shown in schematic layered view with two layers being shown without limit thereto. In FIG. 1, the working element, generally represented at 10, comprises a first FBOPP, 16, with a first conductive layer, 18, coated on one side. A second FBOPP, 16′, with a second conductive layer, 18′, coated on one side is in a layered arrangement with the first FBOPP. As would be realized adjacent metal layers of opposite polarity are separated by FBOPP. For the purposes of discussion the first conductive layer is designated the anode and the second conductive layer is designated the cathode without limit thereto. As would be realized each first conductive layer is physically and electrically separated from the adjacent second conductive layer by FBOPP wherein the FBOPP functions as a dielectric between the first conductive layer and second conductive layer. The first FBOPP and conductive coating and second FBOPP and conductive coating are preferably identical, for manufacturing conveniences, or they may be different to allow for flexibility in manufacturing or design. Conductive pads, 19, are optionally and preferably formed on the conductive layer thereby allowing for the electrical attachment of leads, 21, as known in the art. Adjacent conductive layers are offset to allow for conductivity to a lead and to insure adjacent conductive layers are not commonly terminated as would be readily understood by those of skill in the art.

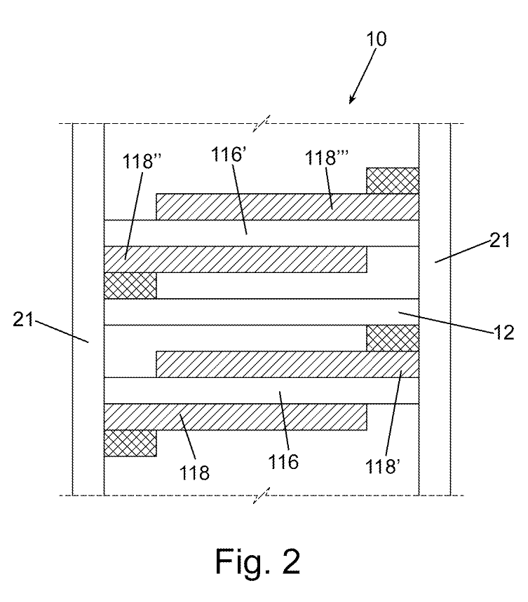

An embodiment of the invention will be described with reference to FIG. 2 wherein a working element is shown in schematic layered view. In FIG. 2, the working element, generally represented at 10, comprises a first FBOPP, 116, with a first conductive layer, 118, coated on a first side and a second conductive layer, 118′, coated on a second side preferably with an offset to allow for termination of adjacent conductors to leads of opposite polarity as would be realized to those of skill in the art. The first FBOPP is in a layered arrangement with a second FBOPP, 116′. A separator, 12, which is preferably a FBOPP layer without any conductive coating, is sandwiched between the first FBOPP and second FBOPP. More specifically, a separater would be between each FBOPP having a conductive layer on each side of the FBOPP. The capacitive couple is formed by adjacent metal layers with FBOPP between each adjacent layer. For the purposes of discussion metal layers 118 and 118″ are designated as anode layers with layers 118′ and 118′″ designated cathode layers without limit thereto.

The cross-sectional size of the FBOPP is not particularly limited and chosen to meet the design limitations including capacitance as a function of available space.

Biaxial stretching to form a biaxially oriented film is a well known technique wherein a roll of film is stretched in a machine direction (MD), which is perpendicular to the width of the film, and transverse direction (TD), which is parallel to the width of the film. Machine direction and transverse direction can be done simultaneously or sequentially. In some instances biaxial stretching is done while the film is in a partially molten state. Biaxial stretching can be accomplished by any technique known in the art such as rolling, uniaxial compression, tenter-frame stretching and the like. Biaxial stretching alters the crystallinity of the polymer thereby altering the properties relative to as-cast material. Biaxial stretched polypropylene is widely available commercially in a variety of suitable thicknesses and therefore further explanation of the process is not warranted herein. Biaxial stretched fluorinated polypropylene with a thickness of less than 6 μm is preferred due to commercial availability.

The conductive layer material is any material which can be coated onto FBOPP to provide a conductive coating and act as the conductor of the capacitor. Metals, carbon and combinations thereof are particularly preferred. Particlarly preferred conductive coatings comprise aluminum, copper, zinc, gold, silver and combinations thereof. The conductive layer is applied by any technique known in the art such as vapor deposition, thermal evaporation, PVD, coating, spraying and the like. The conductive coating is typically applied to a thickness of at least 10 nm to no more than 200 nm.

The operational temperature of the capacitor is significantly improved by fluorination of BOPP to form an FBOPP dielectric film. Direct fluorination of BOPP allows for an increase in operational temperature of the film itself and of the film capacitors made therewith.

The BOPP is preferably fluorinated by a direct fluorination method wherein the film is directly exposed to fluorine gas at a temperature of between about 20° C. and about 150° C. and a fluorine partial pressure of between about 0.01 Bar to about 1.0 Bar. Below about 20° C. insufficient fluorination occurs and above about 150° C. the integrity of the BOPP is compromised prior to adequate fluorination. The fluorination temperature is preferably set initially within a range of about 20° C. to about 40° C. and then increased to a temperature within a range of from about 70° C. to about 100° C. Flourination can be done in the presence of UV activation. It is preferable to maintain the atmosphere and increase the temperature. The atmosphere may also be altered during treatment, however, this is not preferred due to manufacturing conveniences.

A representative example was prepared by an initial treatment for about 24 hour at 25° C. in an atmosphere comprising about 0.1 Bar fluorine and about 0.9 Bar nitrogen. The initial treatment was followed by a 24 hour treatment at about 80° C. in the same atmosphere for convenience. The samples were analyzed by Energy Dispersive X-ray Spectroscopy (EDX). The results are presented in Table 1 wherein the percentage of carbon and fluorine are reported relative to the total concentration of carbon and fluorine in the sample. Other elements are not reported.

TABLE 1

| Spectrum | C % | F % | Flourination % |
|---|---|---|---|
| 10 kv 01 | 61.70 | 38.30 | 31.0 |
| 10 kv 02 | 61.17 | 38.83 | 31.7 |
| 10 kv 03 | 62.86 | 37.14 | 29.5 |
| 10 kv 04 | 67.10 | 32.90 | 24.5 |
| Mean | 63.21 | 36.79 | 29.2 |
| Std. deviation | 2.69 | 2.69 | |
| Max. | 67.10 | 38.83 | |
| Min. | 61.17 | 32.90 | |

As indicated in Table 1, the mean F concentration is approximately 59% of the mean C concentration which corresponds to 29.2% of the H groups being substituted by F which is therefore referred to as about 30% fluorination. No fluorination would be referred to as 0% fluorination, replacing about half of the hydrogens with fluorine would be referred to as 50% fluorination, etc. For the purposes of the instant invention FBOPP is defined as a fluorinated biaxially oriented polypropylene film wherein at least a portion of the hydrogens of the polypropylene polymer are replaced with fluorine. It is preferable that the FBOPP be at least 5% fluorinated. More preferably the FBOPP is at least 10% fluorinated. More preferably, the FBOPP is at least 20%. Most preferably the FBOPP is at least 25% fluorinated. The theoretical maximum for fluorination is 100% wherein all hydrogens are replace with fluorine.

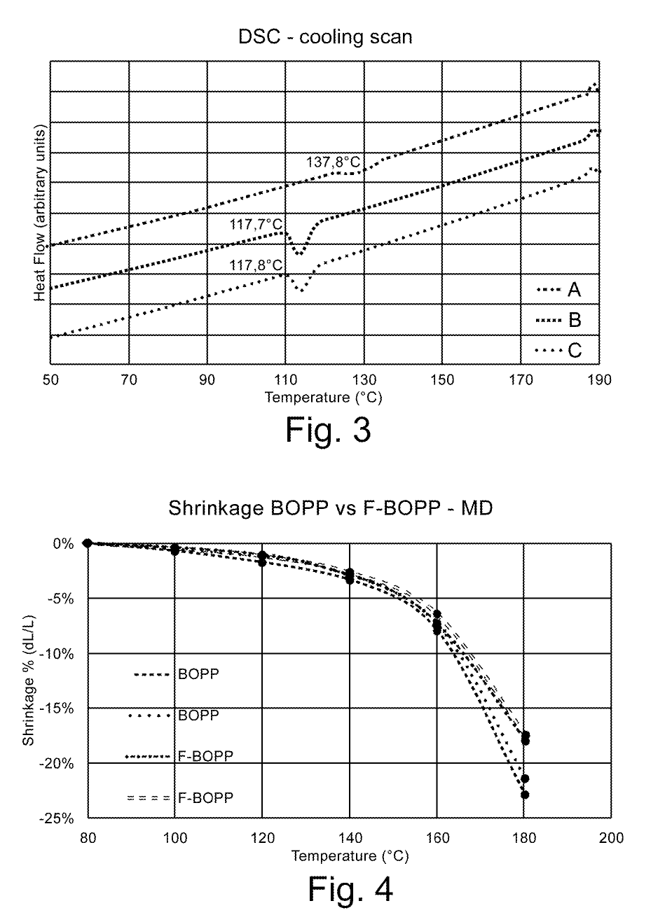

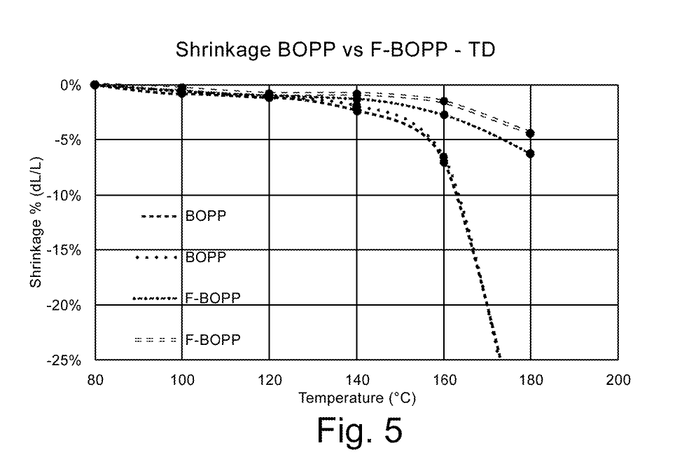

The increase in the operational temperature of the FBOPP, relative to BOPP, prior to coating with a conductor or metal was demonstrated by Differential Scanning Colorimetry (DSC) wherein the crystallization temperature was observed to increase. As evidenced in FIG. 3 the crystallization temperature increased by about 20° C. for the inventive samples. A crystallization temperature of above 120° C. is illustrated in FIG. 3 wherein the DSC was determined with a cooling scan of 10° C./min. In FIG. 3 a) is virgin BOPP; b) is BOPP conditioned in air at fluorination temperature and time to exclude thermal-only effects; and c) is inventive FBOPP with 30% fluorination achieved by treatment at a temperature of about 25° C. in an atmosphere comprising about 0.1 Bar fluorine for 24 hours followed by fluorination at 80° C. in an atmosphere comprising about 0.1 Bar fluorine for 24 h. The shrinkage test results are illustrated graphically in FIG. 4 for the machine direction (MD) and FIG. 5 for the transverse direction (TD).

Shrinkage of FBOPP was improved over BOPP preconditioned at 80° C. for 24 hours, to exclude thermal-only effect, and the improvement is evident in both machine direction (MD) and transverse direction (TD). Shrinkage improvement is also evident at visual inspection wherein the fluorinated samples do not visually show warpage.

The invention has been described with reference to the preferred embodiments without limit thereto. Additional embodiments and improvements may be realized which are not specifically set forth herein but which are within the scope of the invention as more specifically set forth in the claims appended hereto.

Claimed is:

1. A film capacitor comprising:
a first fluorinated biaxially oriented polypropylene film; and
a conductive coating on at least one side of said first fluorinated biaxially oriented polypropylene film.

2. The film capacitor of claim 1 further comprising a second film.

3. The film capacitor of claim 2 wherein said second film and said first fluorinated biaxially oriented polypropylene film are in a layered arrangment.

4. The film capacitor of claim 2 wherein said second film is a second fluorinated biaxially oriented polypropylene film.

5. The film capacitor of claim 4 wherein said second fluorinated biaxially oriented polypropylene film further comprises a conductive coating on at least one side.

6. The film capacitor of claim 5 further comprising a separator between said first fluorinated biaxially oriented polypropylene film and said second fluorinated biaxially oriented polypropylene film.

7. The film capacitor of claim 6 wherein each of said first fluorinated biaxially oriented polypropylene film and said second fluorinated biaxially oriented polypropylene film comprises a conductive coating on each side.

8. The film capacitor of claim 4 wherein said second fluorinated biaxially oriented polypropylene film is a separator.

9. The film capacitor of claim 1 wherein said first fluorinated biaxially oriented polypropylene film comprises a conductive coating on each side.

10. The film capacitor of claim 1 wherein said first fluorinated biaxially oriented polypropylene film is at least 5% fluorinated.

11. The film capacitor of claim 10 wherein said first fluorinated biaxially oriented polypropylene film is at least 10% fluorinated.

12. The film capacitor of claim 11 wherein said first fluorinated biaxially oriented polypropylene film is at least 20% fluorinated.

13. The film capacitor of claim 12 wherein said first fluorinated biaxially oriented polypropylene film is at least 25% fluorinated.

14. The film capacitor of claim 1 wherein said conductive coating comprises metal or carbon.

15. The film capacitor of claim 14 wherein said metal is selected from the group consisting of aluminum, copper, zinc, gold and silver.

16. The film capacitor of claim 14 wherein said conductive coating has a thickness of at least 10 nm to no more than 200 nm.

17. A process for forming a film capacitor comprising:
fluorinating a biaxial oriented polypropylene film to obtain a first fluorinated biaxial oriented polypropylene film;
forming a conductive coating on said first fluorinated biaxial oriented polypropylene film to form a first layer; and
forming a layered structure comprising said first layer and a second layer.

18. The process for forming a film capacitor of claim 17 wherein said fluorinating comprises direct fluorination at a temperature of at least 20° C. to no more than 150° C. in an atmosphere comprising flourine.

19. The process for forming a film capacitor of claim 17 wherein said second layer is a second fluorinated biaxially oriented polypropylene film.

20. The process for forming a film capacitor of claim 19 wherein said second fluorinated biaxially oriented polypropylene film comprises a conductive coating on at least one side.

21. The process for forming a film capacitor of claim 20 wherein said layered structure further comprising a separator between said first layer and said second layer.

22. The process for forming a film capacitor of claim 21 wherein each of said first layer and said second layer comprises a conductive coating on each side.

23. The process for forming a film capacitor of claim 19 wherein said second layer is a separator.

24. The process for forming a film capacitor of claim 17 wherein said first layer comprises a conductive coating on each side.

25. The process for forming a film capacitor of claim 17 wherein said first fluorinated biaxially oriented polypropylene film is at least 5% fluorinated.

26. The process for forming a film capacitor of claim 25 wherein said first fluorinated biaxially oriented polypropylene film is at least 10% fluorinated.

27. The process for forming a film capacitor of claim 26 wherein said first fluorinated biaxially oriented polypropylene film is at least 20% fluorinated.

28. The process for forming a film capacitor of claim 27 wherein said first fluorinated biaxially oriented polypropylene film is at least 25% fluorinated.

29. The process for forming a film capacitor of claim 17 wherein said conductive coating comprises metal or carbon.

30. The process for forming a film capacitor of claim 29 wherein said metal is is selected from the group consisting of aluminum, copper, zinc, gold and silver.

31. The process for forming a film capacitor of claim 17 wherein said conductive coating has a thickness of at least 10 nm to no more than 200 nm.
